(19) United States
(12) Patent Application Publication
(10) Pub. No.: US 2026/0172764 A1
(43) Pub. Date: Jun. 18, 2026

(54) Systems and Methods for Processing Audio Signals

(71) Applicant: Harinath Garudadri, La Jolla, CA (US)

(72) Inventor: Harinath Garudadri, La Jolla, CA (US)

(21) Appl. No.: 19/353,621

(22) Filed: Oct. 9, 2025

Related U.S. Application Data
(60) Provisional application No. 63/705,909, filed on Oct. 10, 2024.

(51) Int. Cl. H04R 25/00

(52) U.S. Cl. CPC H04R 25/505; H04R 2225/39; H04R 2225/43

(57) ABSTRACT

Systems and methods for processing audio signals for hearing loss compensation include: automatically decomposing an input audio signal into a plurality of short-time segments; automatically decomposing at least one of the short-time segments into distinct sub-segments, a first of the distinct sub-segments having linear contributions and a second of the distinct sub-segments having nonlinear contributions; automatically modifying one or more of the linear contributions based on vector quantized hearing loss characteristics specific to a listener; automatically applying a gain to each of the nonlinear contributions; automatically synthesizing one or more of the linear contributions, the one or more modified linear contributions, and a plurality of gain adjusted nonlinear contributions into a reconstructed audio signal; and automatically generating an output audio signal through use of a sound processing device, the output audio signal based on the reconstructed audio signal.

### BACKGROUND

Hearing loss (HL) affects hundreds of millions worldwide. Impaired communication as a result of hearing loss may lead to withdrawal from social interactions, loneliness, and accelerated cognitive decline. Hearing aids (HAs) may be considered as audio devices that modify audio signals and render the modified signals to improve intelligibility and/or acoustic comfort. Many hearing aids are available over the counter (OTC). Over the counter hearing aids (OTC-HAs) may be configured to address minor hearing limitations. More severe hearing limitations are often addressed by an audiologist providing a hearing aid fitting. However, many people suffer from hearing impairments that are not correctable from existing hearing aids. For example, self-reported symptoms from many blast exposed Veterans may be indicative of hearing impairments. Hearing loss symptoms with blast exposures' etiology may not be diagnosed with conventional approaches; and consequently, may not be remedied.

Conventional approaches to processing sound signals for hearing aids may include Wide Dynamic Range Compression (WDRC). In many approaches using WDRC, soft sounds are amplified, and loud sounds are compressed.

Conventional approaches to hearing aid fitting may be based on using prescriptive programs such as, for example, National Acoustics Lab Non-Linear 2 (NAL-NL2), Desired Sensation Level (DSL), and/or Cambridge Fitting protocol (CAM2). Conventional approaches to hearing aid fitting may be limited to addressing Sensorineural Hearing Loss (SNHL). Conventional approaches to hearing aid fitting may use open-loop systems. Conventional approaches to hearing aid fitting may require conventional audiograms.

Problems may arise in conventional approaches when hearing-impaired patients continue to suffer from hearing loss and/or acoustic discomfort. Problems may arise in using conventional OTC hearing aids when hearing-impaired patients with minor hearing limitations need to self-treat instead of working with an audiologist. Working with an audiologist for minor hearing limitations may increase costs and/or time required to address hearing limitations. Problems may arise in conventional approaches when hearing-impaired patients need adjustments to hearing aid parameters for different environments. Problems may arise in conventional approaches when audiologists can't efficiently address patient needs. Problems may arise in conventional approaches when hearing-impaired patients are unable to travel to audiologists.

This Background is provided to introduce a brief context for the Detailed Description that follows. This Background is not intended to be an aid in determining the scope of the claimed subject matter nor be viewed as limiting the claimed subject matter to implementations that solve any or all of the shortcomings or problems presented above.

### BRIEF DESCRIPTION OF THE SEVERAL VIEWS OF THE DRAWINGS

The accompanying drawings, which are incorporated in and constitute a part of this specification, illustrate several embodiments and, together with the description, serve to explain the disclosed principles. In the drawings:

FIGS. 1A and 1B depict block diagrams of systems for processing audio signals.

FIG. 2 depicts a block diagram of a first exemplary system for sound processing, consistent with disclosed embodiments.

FIG. 3 illustrates a block diagram of an exemplary system for addressing exemplary functional hearing deficits (FHD), consistent with disclosed embodiments.

FIG. 4 depicts a block diagram of an exemplary system for listening aid fitting, consistent with disclosed embodiments.

FIG. 5 depicts a block diagram of a first exemplary system for sound processing, consistent with disclosed embodiments.

FIG. 6 depicts a block diagram of a second exemplary system for sound processing, consistent with disclosed embodiments.

FIG. 7 depicts a flow diagram of an example process for processing audio signals for hearing loss compensation, consistent with disclosed embodiments.

FIG. 8A illustrates a typical linear time invariant system.

FIG. 8B illustrates a typical nonlinear time varying system.

FIG. 8C illustrates a piecewise liner, short-time invariant system (PSI), consistent with disclosed embodiments.

FIG. 9 illustrates exemplary equations related to sound processing, consistent with disclosed embodiments.

FIG. 10 depicts a set of exemplary quantized audiograms for an exemplary shape search, consistent with disclosed embodiments.

FIG. 11 illustrates exemplary graphical user interfaces for fine resolution listening aid gain selection in listening aid fitting, consistent with disclosed embodiments.

FIG. 12 illustrates spectrograms of a first exemplary audio signal, the first exemplary audio signal processed with a conventional system, and the first exemplary audio signal processed with at least one of the disclosed embodiments.

FIG. 13 illustrates spectrograms of a second exemplary audio signal, the second exemplary audio signal processed with a conventional system, and the second exemplary audio signal processed with at least one of the disclosed embodiments.

### DETAILED DESCRIPTION OF EMBODIMENTS

Consistent with disclosed embodiments, systems and methods for processing audio signals are disclosed.

Disclosed systems and methods may provide devices and/or applications for audio signal processing. The audio signal processing may be used by normal-hearing (NH) subjects. The audio signal processing may be used by hearing-impaired (HI) subjects. A subject matter expert (SME) may assist NH subjects to cope with their communication difficulties in different environments. The audio signal processing may be used as a software upgrade by listeners with access to commercial, off-the-shelf (COTS) mobile devices, earbuds, headsets, etc. and/or applications using any of the disclosed systems and methods.

Consistent with disclosed embodiments, systems and methods for improving the audio quality of hearing aids are disclosed. Some of the disclosed systems and methods may be utilized to eliminate audio artifacts such as “tinny, shrill, static-filled, scratchy” in conventional hearing aids.

Consistent with disclosed embodiments, the pristine audio quality of a hearing loss intervention may result from the use of Crest Factor Volume for maintaining the audibility of processed audio comparable to that of a conventional hearing aid with a compressive-amplification, simultaneously improving the intelligibility at a loudness level selected by an NH or HI person.

Disclosed systems and methods may be based on providing Over The Counter (OTC) Hearing Aids (HAs) to HI subjects. HI subjects may benefit from consulting audiologists for rehabilitation strategies with improved audio quality. Providing effective OTC-HAs may reduce costs for hearing-impaired patients, health care providers, and/or health insurance providers.

OTC-HAs may include ear buds, headsets, and neck bands in communication with one or more devices configured to execute any portion of the disclosed systems and/or methods. Examples of devices include but are not limited to smartphones, tablets, wearables, hearables, PSAPs, and/or cloud servers.

Disclosed systems and methods may be configured to provide clinically dispensed Hearing Aids (HAs) to NH and HI persons working with an audiologist to alleviate symptoms akin to those associated with hearing loss (HL) and hearing loss related disorders (HLRD).

Disclosed systems and methods may provide improved sound quality of a hearing aid in both clinical dispensing and OTC dispensing. Disclosed systems and methods may enable SMEs to work with hearing-impaired listeners remotely.

Disclosed systems and methods may be configured to follow the temporal dynamics of an input signal. The input signal may comprise an audio stream or multi-channel audio.

Disclosed systems and methods may provide devices and/or applications for HL rehabilitation. Disclosed systems and methods may be configured to process input sounds after converting the input sounds to one or more input audio signals. Disclosed systems and methods may provide a Hearing Aids Programming Interface (HAPI). The HAPI may be configured to receive sound processing parameters. The HAPI may be configured to receive a range for each of a plurality of sound processing parameters. The HAPI may be configured to receive a resolution for each of a plurality of sound processing parameters. Disclosed systems and methods may be configured to create interventions for each member of the quantized auditory perceptual space based on parameters received through utilization of the HAPI. The HAPI may be configured to provide sound processing parameter values. The HAPI may be configured to communicate with a SME device. The HAPI may be configured to communicate with a listener device.

As used herein, an audiogram is a partial diagnosis of hearing loss disease state across a plurality of frequency bands within the auditory spectrum. Specifically, the audiogram captures the nature of the disease state in the spectral domain alone, and not the temporal dynamics of the input audio signal.

As used herein, a Pure Tone Audiogram (PTA) is a conventional audiogram generated as a result of pure tone audiometry.

As used herein, a hearing aid fitting is equivalent to a hearing aid prescription.

As used herein, a hearing aid fitting may be referred to as a hearing aid prescription. As used herein, a listener may be an HI patient or an NH person as determined by the current gold standards for HL screening and diagnosis.

As used herein, a subject matter expert (SME) may comprise a skilled professional who is skilled in rehabilitation for diminished sensory stimulus comprehension. SMEs may include, but are not limited to, audiologists, optometrists, and medical practitioners.

As used herein, self-fitting in the spirit of disclosed embodiments for HL/HLRD intervention may also be referred to as self fitting or SelfFitting.

As used herein, devices and/or applications using any of the disclosed embodiments may be referred to as a listening aid.

As used herein, crest factor is a measurement of a signal that indicates the ratio of peak amplitude to Root Mean Square (RMS) of the signal over a time-window of observation. Crest factor may be used to determine how extreme the peaks of a signal compare to an average perceived loudness of the signal.

Embodiments consistent with the present disclosure may include a system for processing audio signals for hearing loss compensation. The system may comprise a sound processing device. The sound processing device may be configured to generate an output audio signal. The output audio signal may be based on an input audio signal and one or more sound processing parameter settings. The system may comprise a database. The database may comprise vector quantized hearing loss characteristics across a range of audio frequencies. At least one of the sound processing parameter settings may be based on vector quantized hearing loss characteristics specific to a listener. The system may comprise at least one memory storing instructions. The system may comprise at least one processor configured to execute the instructions to perform operations. The operations may comprise automatically decomposing the input audio signal into a plurality of short-time segments. The operations may comprise automatically decomposing at least one of the short-time segments into distinct sub-segments. A first of the distinct sub-segments may comprise linear contributions. A second of the distinct sub-segments may comprise nonlinear contributions. The operations may comprise automatically modifying one or more of the linear contributions based on the vector quantized hearing loss characteristics specific to the listener. In cases where the listener has no hearing loss in a specific frequency range, the corresponding linear contributions for the specific frequency range may be interpolated. The operations may comprise automatically applying a gain to each of the nonlinear contributions. In some cases, the gain may be set to zero gain. The operations may comprise automatically modifying one or more of the linear contributions, one or more modified linear contributions, and a plurality of gain adjusted nonlinear contributions into a reconstructed audio signal. The operations may comprise automatically generating the output audio signal through use of the sound processing device. The output audio signal may be based on the reconstructed audio signal.

In some embodiments, decomposing an input audio signal into short-time segments may be configured to perform model projections. Sub-segments comprising linear contributions may be based on the model projections.

In some embodiments, decomposing an input audio signal into short-time segments may be configured to identify signal components omitted by a model. The short-time segments comprising nonlinear contributions may be based on signal components omitted by the model.

In some embodiments, a gain may be selected by a user. A gain may be applied to one or more nonlinear contributions. A user may be a NH or HI person.

In some embodiments, an additional gain may be automatically selected. The additional gain may be based on a vector quantized hearing loss characteristic in the database.

In some embodiments, the specific vector quantized hearing loss characteristic may be determined through one or more selections of preferred audio processing of a stimulus by the NH or HI person. For example, a stimulus may be played to the listener. The stimulus may be played a plurality of times. Each of the plurality of times may be associated with a specific audio processing of the stimulus. The listener may select one or more preferred audio processing of the stimulus.

In some embodiments, a gain may be based on one or more listener preferences. A listener preference may comprise a preferred crest factor volume of a specific stimulus or audio signal. A listener preference may be a result of Two Alternate Forced Choice (2AFC). A listener preference may be a result of n Alternate Forced Choice (nAFC) where n is more than two. In some embodiments, reconstruction of output audio may be based on one or more listener preferences.

Embodiments consistent with the present disclosure may include a method for processing audio signals for hearing loss compensation. The method may comprise automatically decomposing an input audio signal into a plurality short-time segments. The method may comprise automatically decomposing at least one of the short-time segments into distinct sub-segments. A first of the distinct sub-segments may comprise linear contributions. A second of the distinct sub-segments may comprise nonlinear contributions. The method may comprise automatically modifying one or more of the linear contributions. Modifying one or more of the linear contributions may be based on vector quantized hearing loss characteristics specific to a loss characteristic in the database. In cases where the listener has no hearing loss in a specific frequency range, the corresponding linear contributions for the specific frequency range may be interpolated. The method may comprise applying a gain to each of the nonlinear contributions. In some cases, the gain may be set to zero gain. The method may comprise automatically modifying one or more of the linear contributions, one or more modified linear contributions, and a plurality of gain adjusted nonlinear contributions into a reconstructed audio signal. The method may comprise automatically generating an output audio signal through use of a sound processing device. The output audio signal may be based on the reconstructed audio signal.

Some embodiments may include a Finite Impulse Response (FIR) filter. The FIR filter may be configured based on vector quantized hearing loss characteristics specific to a hearing loss characteristic in the database.

Embodiments consistent with the present disclosure may include a piecewise linear, short-time invariant (PSI) system. Systems and methods consistent with the present disclosure may be configured to decompose an audio signal into short-time stationary contributions. The terms short-time invariant and short-time stationary are used synonymously. The contributions may comprise linear components based on a model. Compensation of the linear components may be based on a measured audiogram or a selected audiogram. Audiograms may be estimated based on the “linearity” assumption. Audiogram-based spectral compensation of the input signal may be made in a similar manner to that of adjusting a stereo equalizer. The nonlinear contributions may further comprise components that are not captured by models based on the linearity assumption. The components that are not captured by linear models may be considered nonlinear contributions. A gain may be applied to nonlinear components. Systems and methods consistent with the present disclosure may be configured to modify linear components for a specific audiogram. Systems and methods consistent with the present disclosure may be configured to process the components not captured by the model through use of piecewise linear algorithms.

In some embodiments, a process for processing audio signals for HL intervention may be configured to fine tune one or more system parameters in real-time to improve the sound quality to one or more specific environments. A process for processing audio signals for HL intervention may be configured to fine tune one or more system parameters in real-time to improve intelligibility and/or to alleviate symptoms akin to those of HL/HLRD.

Embodiments consistent with the present disclosure may include speech-based fitting. Speech-based fitting may be implemented as a closed loop between presenting speech-based audio stimuli to an NH or HI person to optimize intelligibility and/or acoustic comfort. This closed-loop approach with an NH or HI person may be referred to as Diagnosis by Intervention (DBI). Speech-based fitting may comprise a shape fit. A shape fit may comprise selection of a hearing loss shape from a database of hearing loss shapes. The HL intervention parameters may include one or more gain settings. A gain setting may be specific to a specific frequency band in a plurality of audio frequency bands. Speech-based fitting may comprise optimizing HL intervention parameters after a listener responds to each stimulus in a fitting process. Speech-based fitting may comprise determining a self-selected audiogram that may be representative of the current gold standard hearing loss characterization.

As used herein, the term “space” refers to a mathematical construct where each point in the N-dimensional space is exactly represented by N variables (x₁, x₂, . . . , xₙ). This is the space of all possible vectors in the N-dimensional Euclidean space, denoted by [symbol] . For example, the space of all possible audiograms is [symbol] , when audiograms are measured at 10 audiometric frequencies and corresponds to the “diagnosis space” in this disclosure. For a given hearing sound processing based on WDRC with, for example, 11 bands, there may be 66 parameters, specified by NAL-NL2. These parameters may correspond to gains for inputs at 65 dB SPL (g65), Compression Ratio (CR), Attack Time (AT), Release Time (RT), Knee_low point where compressive amplification starts, and the maximum power output in each band (MPO_per_band). The space represented by [symbol] may be referred to as the “intervention space.”

In conventional pure tone audiometry, the resolution for hearing loss thresholds (HLTs) at a given frequency may be limited. For example, HLTs may be represented with 8 bit integers. In this example, there are 256 unique points in each dimension in the [symbol] space, resulting in more than 1.2e+24 points in the diagnosis space. For example, the intervention space may comprise 2\hat{ }=4096 unique points in each dimension. In this example [symbol] will result in a total of 2.6e+238 points. In this example, the diagnosis space and the intervention space may be too large to search efficiently in real time.

In some embodiments, the diagnosis space may be vector quantized to a codebook of size S for a hearing loss shape. The vector quantizing may provide an efficient search space. The quantized diagnosis space may be referred to as quantized auditory perceptual space (QuAPS).

In some embodiments, parameters for hearing loss intervention may be determined offline based on a given prescription formulae for each point in QuAPS, resulting in a 1-to-1 correspondence between the diagnosis space and the intervention space. The QuAPS and the corresponding intervention space may be stored in a database configured for efficient searching. Searching in the intervention space as a proxy to searching for a hearing loss diagnosis in the diagnosis space may be referred to as Diagnosis by Intervention (DBI).

The accuracy of diagnoses deduced from an intervention may be influenced by the utility of the intervention. In some embodiments, the utility of a given intervention may be assessed objectively and subjectively.

Some embodiments consistent with the present disclosure teach objective metrics that may be consistent with the triangular inequality principle. Examples of such metrics may be found in the International System of Units (SI) and may include, for example, distance, mass, time, candela, etc.

Some embodiments consistent with the present disclosure teach subjective metrics that may be consistent with the triangular inequality principle, subject to the tolerances estimated by Just Noticeable Differences (JND). Examples of such metrics may be found in the International System of Units (SI), for e.g., distance, mass, time, candela, etc.

Some embodiments may comprise multiple searches. During each search, an NH or HI person may be prompted to listen to a plurality of stimuli and provide a response comprising a preferred stimulus. A search may comprise a hearing loss shape search. Speech-based fitting may not need an audiogram to fit HAs. Shape search may be based on a set of clustered audiograms, but the subject provides preferences based on stimuli processed with some embodiments consistent with the present disclosure. Specifically, the audio processing based on Crest Factor Volume Control may provide a desired level of amplification for audibility, simultaneously improving the intelligibility, as measured with psychometric measurements including, but not limited to 2AFC, 4AFC, Likert functions, etc. Therefore, searching the intervention space with feedback from a listener may be equivalent to searching the diagnoses space of audiograms, because of 1-to-1 mapping between the diagnoses space and prescriptive gains. The use of CFV in search of a perfect fit may result in user selected gains. This is in contrast with the prescriptive gains approach in the conventional approach to dispensing hearing loss interventions. Thus, the user selected audiogram, a byproduct of searching the intervention space constructed with CFV may be different from the measured audiogram. The measured audiogram may be called φ and the selected audiogram may be called φ′.

Embodiments consistent with the present disclosure may be configured to provide a diagnosis and an optimal intervention based on listener preferences for audibility, quality and intelligibility. The diagnosis and the optimal intervention may be provided at the termination of one or more searches.

Embodiments consistent with the present disclosure may include a Learned Machine (LM). A LM may be configured to generate Actionable Information (AI). A LM may be configured to access a plurality of quantized audiogram models. The quantized audiogram models may be defined by QuAPS. The quantized audiogram models may be organized. For example, the quantized audiogram models may be organized in ascending order of hearing loss. The quantized audiogram models may be based on a large corpus of real-world audiogram shapes. The audiograms database may include both measured and selected audiograms from multiple NH and HI persons. A LM may be configured to conduct unsupervised, data-driven clustering. For example, the LM may be configured to perform data-driven k-means clustering. A LM may be configured to select stimuli to be presented to a NH or HI person seeking assistance with communication during activities of daily living. A LM may be configured to control a stimulus presentation. A LM may be configured to guide the listener to choose optimal hearing parameters. A LM may be configured to control sound processing for a given intervention. A LM may be configured to receive responses from the listener on the perceived sound. A LM may be configured to store responses to each stimulus and/or sound processing used for each listener in a local database. A LM may be configured to upload listener behavior to one or more servers. A LM may be configured to upload listener behavior in different environments to one or more servers. A LM may be based on one or more local quantized audiogram models. A LM may be based on one or more global quantized audiogram models. A LM may comply with one or more HIPAA or similar regulations.

Embodiments consistent with the present disclosure may be configured to communicate with one or more remote devices and/or remote databases. The remote devices and/or remote databases may be contained in a HIPAA compliant cloud. One or more of the remote devices and/or remote databases may be configured to access or store metadata based on listening aid fittings for a plurality of listeners. The metadata may be based on vector quantized hearing loss characteristics for a plurality of listeners. The metadata may be based on hearing loss interventions for a plurality of listeners. A LM may be configured to utilize the metadata to improve hearing loss interventions. A LM may be configured to utilize the metadata to improve objective metrics and subjective psychometrics.

Some embodiments may include searching for an optimal fit or a perfect fit for N=1, a given NH or HI person. The perfect fit may be searched in the intervention space by NH and HI persons in a closed loop language based search. Systems and methods configured to search for the perfect fit in the intervention space may be configured to search in the quantized auditory perceptual space φ′ with a countably finite number of measured and selected audiograms. Systems and methods configured with CFV assisted interventions may be configured to create the intervention space represented by superscript a and for a given fitting protocol represented by subscript k. In the present disclosure, such systems are represented by

$${H}_{k}^{a} .$$

Systems and methods configured for a perfect fit may be configured to provide a one-to-one correspondence between a quantized auditory perceptual space and an intervention space. This one-to-one correspondence may provide more optimal listening experience for listeners over conventional prescriptive hearing loss interventions based on compressive-amplification in multiple spectral bands.

Some embodiments may include a phonetic confusion matrix. Examples of phonetic confusion matrices include place of articulation and/or manner of articulation. Examples of place of articulation include but are not limited to bilabials, alveolars, and velars. Examples of manner of articulation include but are not limited to stops, fricatives, affricates, glides, and vowels.

Some embodiments may be used to evaluate outcomes for WDRC-based sound processing and audiogram-based fitting.

Some embodiments may be used to evaluate outcomes for OTC hearing aids compared with outcomes of disclosed systems and methods.

Some embodiments may be configured for multi-lingual support. Hearing loss interventions may be optimized for one language over another language. Hearing loss interventions may be optimized for more than one specific language. Hearing loss interventions may be based on one or more multi-lingual preferences of NH and HI persons.

Some embodiments may be used for real-time language translation.

Some embodiments may include Crest Factor Control (CFC). CFC may be used to assess a dynamic range of a signal. CFC may be used to assess potential clipping risks of a signal being processed by a given system or system component. In one embodiment, the signal is a time series, sampled at uniform intervals or non-uniform intervals. CFC may be used to preserve pristine output signal quality. CFC may be used to balance audio levels. CFC may be used to control a Crest Factor Volume (CFV). A CFV may be used as a gain setting. A CFV may be applied to one or more nonlinear components. A CFV may be applied in a time domain. CFC may be used to monitor an audio signal for intensity. CFC may be used to prevent clipping. CFC may be used for loudness normalization. CFC may be configured to estimate one or more sound parameters x times per second. A value for x may be based on observed stationary regions in a time series of the signal. For example, x may comprise 50 times per second.

In one embodiment, CFC may be configured to align the state of a system represented by

$${H}_{k}^{a}$$

with the temporal dynamics of the system input X, at non-uniform intervals. The system may be configured with acoustic-phonetic representations of input X. For example, vocalic segments like /a, e, I, u, . . . / may retain a specific state longer than non-vocalic segments such as /p, t, k, f, d, ng, r, . . . /. This control loop based on acoustic phonetics may be different from the control loop that estimates hearing loss intervention parameters once every 20 ms, resulting in 50 updates per second.

Reference will now be made in detail to example embodiments, examples of which are illustrated in the accompanying drawings and disclosed herein. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

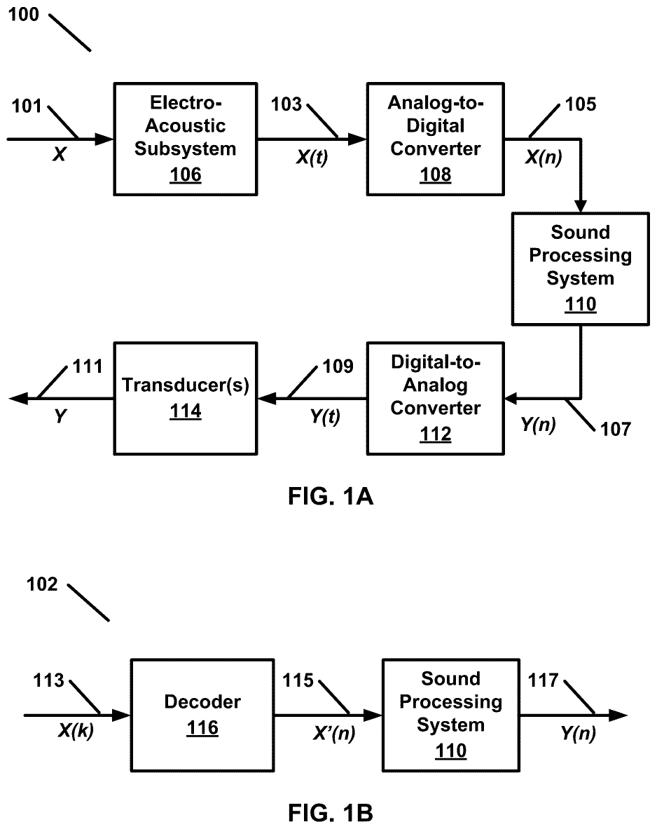

FIGS. 1A and 1B depict block diagrams of systems 100 and 102 for processing audio signals. In system 100, X 101 and Y 111 represent physical signals. Signals X 101 and Y 111 may comprise voice audio signals and/or multitone audio signals. X(t) 103 and Y(t) 109 represent electrical signals. Signals X(t) 103 and Y(t) 109 are analog signals in a time domain. X(n) 105 and Y(n) 107 represent electrical signals. Signals X(n) 105 and Y(n) 107 are digital signals in a time domain.

System 100 may comprise an electro-acoustic subsystem 106. The electro-acoustic subsystem 106 may be configured to convert physical signals into electrical signals. The electro-acoustic subsystem 106 may comprise one or more microphones. System 100 may comprise an analog-to-digital converter 108. The analog-to-digital converter 108 may be configured to convert analog signals into digital signals. System 100 may comprise a sound processing system 110. Examples of sound processing systems include, but are not limited to, hearing aids, ear buds, headsets, neck bands, and other devices configured for sound processing. Sound processing system 110 may be configured to improve the quality and intelligibility of target audio in signal X(n) 105. The target audio in signal X(n) 105 may be accompanied by competing audio sources in signal X(n) 105 (for example, background noise). Sound processing system 110 may be configured to output signal Y(n) 107 given signal X(n) 105 as input. System 100 may comprise a digital-to-analog converter 112. The digital-to-analog converter 112 may be configured to convert digital signals into analog signals. System 100 may comprise one or more transducers 114. The one or more transducers 114 may be configured to convert electrical signals into physical signals. The one or more transducers 114 may comprise one or more loud speakers.

In system 102, signal X(k) 113 comprises a representation of signal X(n) 105, but in a compressed domain. The format of signal X(k) 113 may be optimized for wireless communication using an unlicensed spectrum (for example, 2.4 GHz band) or a licensed band (for example, 5G cellular telecommunications). The process of compressing signal X(n) 105 to signal X(k) 113 and reconstructing signal X′(n) 115 is a lossy process. Some standards bodies for consumer products and services (for example, the Motion Pictures Experts Group, the 3rd Generation Partnership Project) have developed algorithms to ensure that just noticeable differences (JND) between signal X(n) 105 and signal X′(n) 115 may be acceptable for consumer products and services.

System 102 may comprise a decoder 116. The decoder 116 may be configured to decode signal X(k) 113 into signal X′(n) 115. System 102 may comprise sound processing system 110. Sound processing system 110 may be configured to output signal Y(n) 117 given signal X′(n) 115 as input.

In some embodiments, the hearing loss intervention parameters may span a plurality of auditory frequency bands. Auditory frequency bands may be included in the auditory spectrum. The auditory spectrum may comprise frequencies, for example, from 250 Hz to 16 kHz.

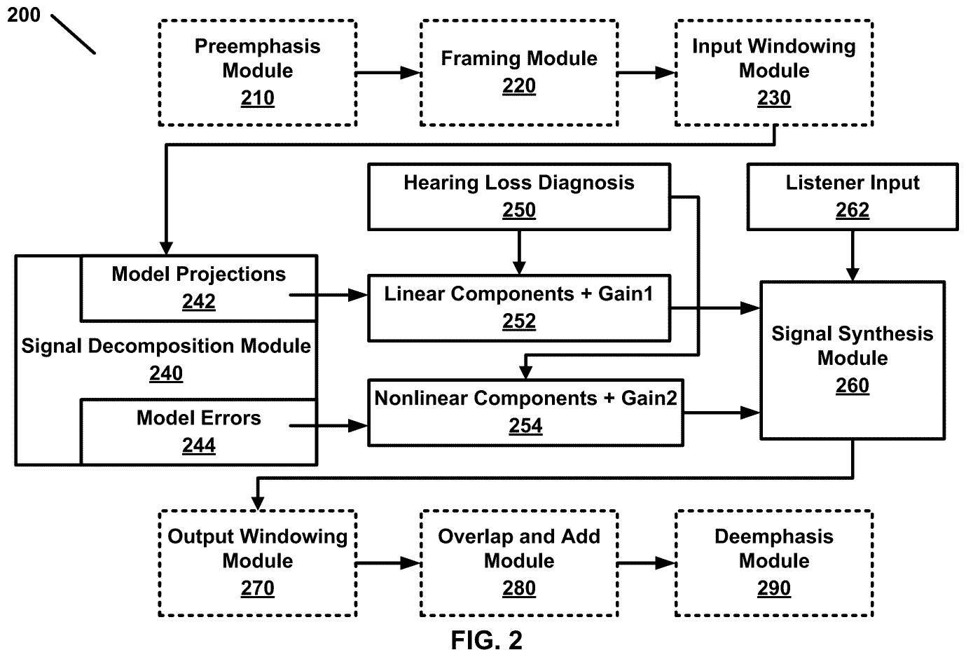

FIG. 2 depicts a block diagram of a first exemplary system 200 for sound processing, consistent with disclosed embodiments. System 200 may comprise a preemphasis module 210. System 200 may comprise a framing module 220. The framing module 220 may be configured to define a period of observation. For example, a period of observation may comprise a range of 5-200 ms. System 200 may comprise an input windowing module 230. The windowing module 230 may be configured to preserve the “perfect reconstruction” property when combined with the output windowing module 270. System 200 may receive the windowed frames from 230, one frame at a time, in realtime. System 200 may comprise a signal decomposition module 240. Signal decomposition module 240 may be configured to decompose an audio frame into (a) projections on a linear model, and (b) the signal components that were not captured by the said linear model. In the literature, such decomposition was described as “ignorance modeling,” to convey the spirit of finding useful models. In some situations, such approaches have also been described as “signal innovations,” to convey the reality of one cannot predict the nature of signals—especially the evolving temporal dynamics. Ignorance modeling may refer to the system model and innovations in the signals indicate a need to adapt the system

$${H}_{k}^{a}$$

accordingly. Signal decomposition module 240 may be configured to perform model projections 242. Signal decomposition module 240 may be configured to identify model errors 244. The model errors 244 may be referred to as signal innovations not covered by the model. The contributions may comprise linear components 252 based on model projections. A first gain (Gain1) may be applied to linear components 252. The first gain applied to linear components 252 may be zero. The contributions may comprise nonlinear components 254 that are not captured by the model projections. Nonlinear components 254 may be contained in an error signal. A second gain (Gain2) may be applied to nonlinear components 254. The second gain applied to nonlinear components 254 may be based on a hearing loss diagnosis 250, a listener preference, and/or a gain correction term. The first gain may be distinct from the second gain. System 200 may be configured to modify linear components for a specific hearing loss. Hearing loss diagnosis 250 may comprise either a measured audiogram or a selected audiogram. Hearing loss diagnosis in the format of an audiogram 250 may result from a self-fitting or Shape search step performed by the NH and HI persons in selecting an intervention. System 200 may be configured to process nonlinear components 254 through use of one or more piecewise linear input/output loudness relationships, akin to those used in conventional HL interventions. System 200 may comprise a signal frame reconstruction module 260. In the present disclosure, the terms reconstruction and synthesis are used synonymously. Signal synthesis module 260 may be configured to combine the output of linear components plus Gain1 252 with the output of nonlinear components plus Gain2 254. Signal reconstruction module 260 may be configured to accept listener input 262. System 200 may comprise an output windowing module 270. System 200 may comprise an overlap and add module 280. System 200 may comprise a deemphasis module 290. An input to signal decomposition module 240 may comprise a frame of a windowed signal x(n).

In some embodiments, a signal decomposition module may be configured to perform Linear Predictive Coding (LPC). An outcome of LPC may comprise an all-pole model. In some embodiments, a signal decomposition module may be configured to perform Matching Pursuits (MP). MP may be configured as an iterative algorithm configured to approximate an input signal as a linear combination of members of dictionary and corresponding coefficients. Upon termination, MP may result in the linear components of the signal. MP residual may represent the nonlinear components of the signal. A dictionary may comprise orthogonal elements. Examples of orthogonal elements include, but are not limited to, Fourier, Gabor, Wigner, and Wavelets. A dictionary may comprise elements learned from a large corpus of data. Examples include, but are not limited to, Principal Component Analysis, K-Singular Value Decomposition, and Sparse Bayesian Learning. A selected set of dictionary elements from MP after each iteration may be “orthogonalized” resulting in Orthogonal MP. Linear contributions may be estimated through use of Sparse Bayesian Learning. Linear contributions may be used to estimate the residual or the nonlinear components. Linear and nonlinear components may be estimated through use of a Least Absolute Shrinkage and Selection Operator (LASSO).

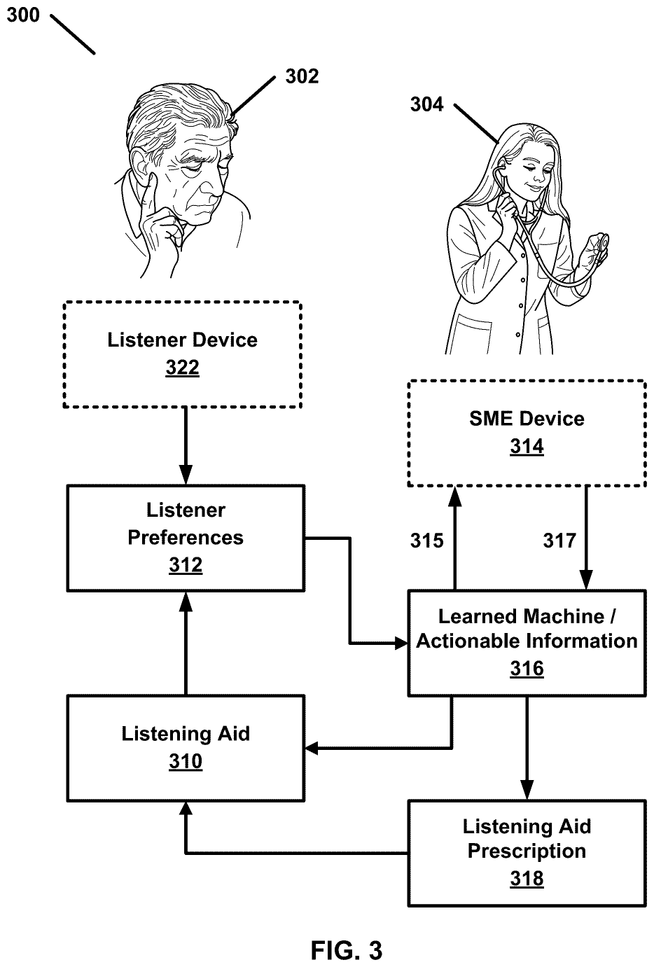

FIG. 3 illustrates a block diagram of an exemplary system 300 for addressing exemplary functional hearing deficits (FHD), consistent with disclosed embodiments. A system 300 may be configured to provide a closed-loop, language-based fit for a listener 302 of a listening aid 310. System 300 may comprise a learned machine 316. The learned machine 316 may be configured to generate Actionable Information (AI). The learned machine 316 may be configured to communicate listener interaction data 315 to an SME device 314. The learned machine 316 may be configured to receive parameter input 317 from an SME 304 utilizing the SME device 314. The learned machine 316 may be configured to receive a one or more listener preferences 312 from the listener 302. The listener 302 may utilize listener device 322 to communicate one or more listener preferences 312 to system 300. The one or more listener preferences 312 may comprise a selection of a preferred stimulus from a plurality of speech-based stimuli. System 300 may be configured to communicate listening aid prescription 318 to listening aid 310. For example, the listening aid prescription 318 may comprise preferred gains selected by the listener 302. Learned machine 316 may be configured to adjust one or more listening aid prescription 318. Learned machine 316 may be configured to select a stimulus to be processed through utilization of listening aid 310. System 300 may be configured to select a plurality of stimuli for a given set of listening aid prescription 318. System 300 may be configured to change one or more listening aid parameters for a given stimulus.

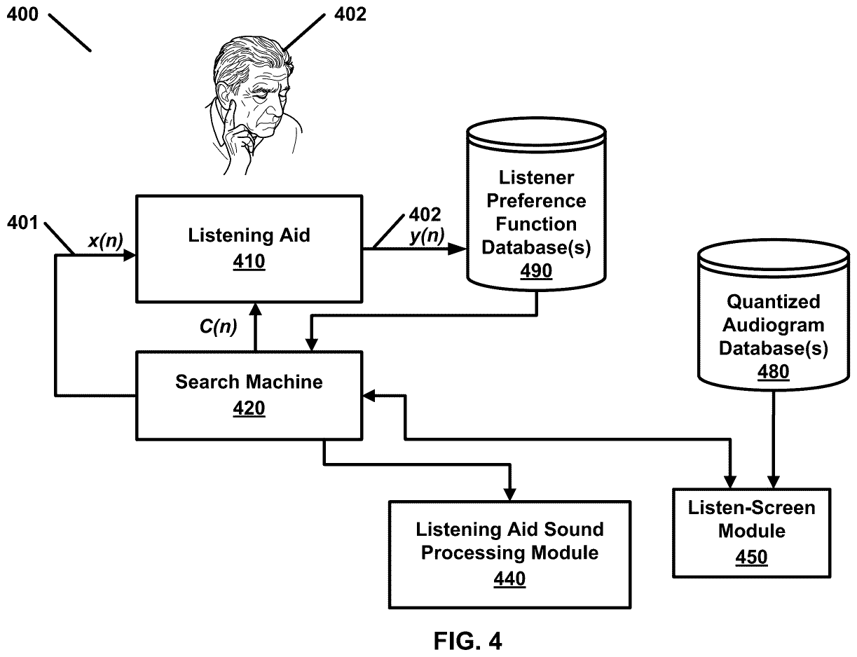

FIG. 4 depicts a block diagram of an exemplary system 400 for listening aid fitting, consistent with disclosed embodiments. System 400 may comprise a listening aid 410 configured to produce output signal 402 given input signal 401 and listening aid parameters C(n). Output signal 402 may be represented by y(n). Input signal 401 may be represented by x(n). System 400 may comprise a search machine 420. The search machine 420 may include a learned machine. The learned machine may be configured to perform searching. Searching may comprise shape searching. The search machine 420 may be configured to adjust listening aid parameters C(n). The search machine 420 may be configured to accept SME input from an SME 404 utilizing an SME device 414. System 400 may be configured to store all SME inputs for a plurality of listeners of a plurality of listening aids. The search machine 420 may be in communication with one or more quantized audiogram databases 480 through utilization of a listen-screen module 450. Each quantized audiogram database 480 may be configured to store a plurality of quantized audiograms. Listen-screen module 450 may be configured to generate a listening aid prescription for each quantized audiogram in QuAPS. Listen-screen module 450 may be configured to provide on-demand audibility changes, pristine audio quality, and improved intelligibility in the output signal of listening aid 410 for a specific listener. System 400 may be configured to present a plurality of speech-based stimuli to a listener 402 of the listening aid 410. The search machine 420 may be configured to receive a selection of a preferred stimulus from listener preference function database 490. The listener preference function database 490 may be configured to store all preference selections from listener 402 of listening aid 410. System 400 may be configured to store all preference selections from a plurality of listeners of a plurality of listening aids. System 400 may be configured to select quantized audiogram φ′ for listener m. The search machine 420 may be in communication with listening aid sound processing module 440. The listening aid sound processing module 440 may be configured to process the speech-based stimuli for the selected quantized audiogram in the current search. System 400 may be configured to store all searches conducted by search machine 420. System 400 may be configured to store all adjustments to listening aid parameters C(n) for each of a plurality of listeners of a plurality of listening aids.

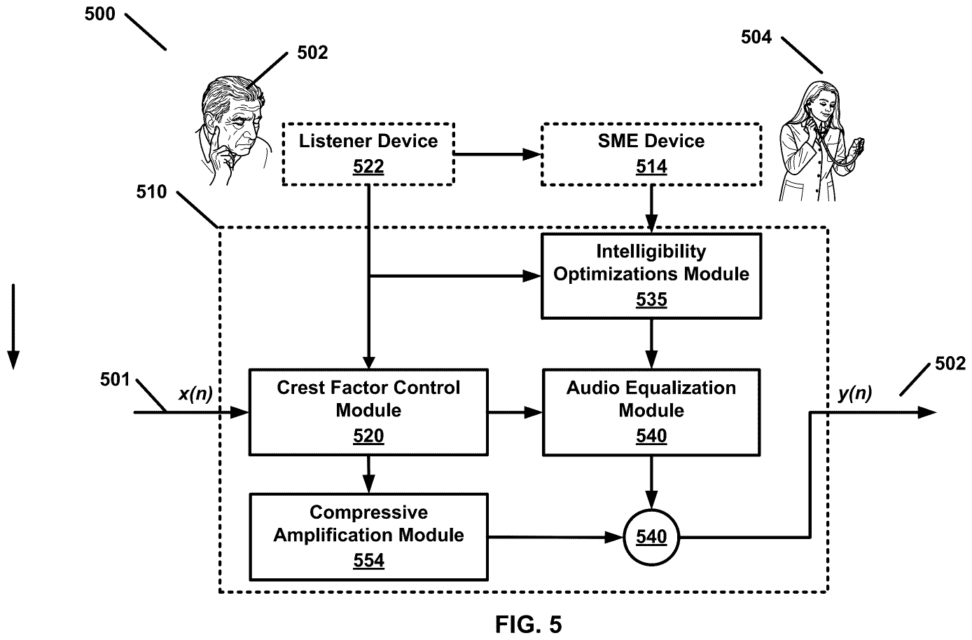

FIG. 5 depicts a block diagram of a first exemplary system 500 for sound processing, consistent with disclosed embodiments. System 500 may comprise listening aid 510. An input to system 500 may comprise input signal 501. Input signal 501 may be represented by x(n). An output of system 500 may comprise output signal 502. Output signal 502 may be represented by y(n). System 500 may comprise a crest factor control module 520. Crest factor control module 520 may be configured to modify the crest factor of the input signal x(n). Crest factor control module 520 may be configured to control one or more crest factors of one or more audio objects. Crest factor control module 520 may comprise a regression model. Crest factor control module 520 may comprise one or more instantaneous, loudness models. Crest factor control module 520 may be configured to set parameters for listening aid 510 based on input from a listener 502 through use of listener device 522.

System 500 may comprise intelligibility optimizations module 535. Intelligibility optimizations module 535 may be configured to receive either a measured or a selected audiogram. The Intelligibility optimizations (IntOps) module 535 may be configured to generate a full band finite impulse filter (FIR) parameters to enable NH, HI, and SMEs to optimize the output y(n) for intelligibility at a preferred audibility for the given environment. IntOps 535 may be configured to accept one or more listener preferences from listener device 522. Intelligibility optimizations module 535 may be configured to accept one or more SME inputs from an SME 504 utilizing SME device 514. Intelligibility optimizations module 535 may be configured with a graphical user interface akin to those on home stereos and other consumer electronic devices for their preferences. Typical presets may include a favorite concert hall, boost the prominence of dialogues above the competing sound effects in 3-D spatial audio movies.

System 500 may comprise audio equalization module 540, an FIR filter. The filter order may be in the range of 16 to 32 taps. Audio equalization module 540 may be configured to modify one or more of linear contributions of input signal 501. Modification of linear contributions may be based on vector quantized hearing loss characteristics specific to a listener.

System 500 may comprise compressive amplification module 554. Compressive amplification module 554 may be configured to apply gains to the components that were not captured by the linear prediction filter. With CFV, piece-wise linear input/output amplitude gain curves similar to those in conventional compressive amplification models are leveraged, but on the signal innovations, rather than the input signal 501.

System 500 may comprise function 540. Function 540 may be configured to reconstruct output y(n). Note that the two parts resulting from the CFV 520 module may be in different domains. For example, the output of the regression model may be a time series; the compressive-amplification module 554 operates in the loudness or intensity of each sample in the time series. In math, sqrt(x(k)\hat{ }2) represents the instantaneous intensity at the time instance of sample k. Unlike in WDRC, CFV applies compressive amplification to e(k), the time series represented by the innovations in the input signal x(n).

System 500 may be configured to modify linear components for a specific hearing loss. Hearing loss diagnosis may comprise either a measured or a selected audiogram. Hearing loss diagnosis may comprise a selected preference by a listener of listening aid 510. The listener may select one or more preferences through listener device 522. Listener device 522 may be in communication with SME device 514 and/or listening aid 510 through one or more cloud services.

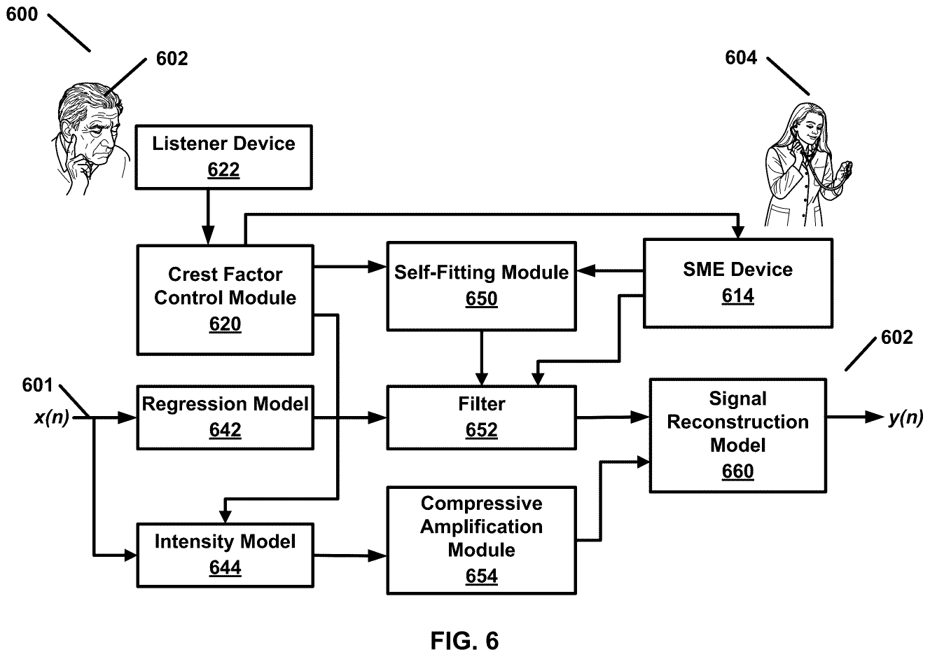

FIG. 6 depicts a block diagram of a second exemplary system 600 for sound processing, consistent with disclosed embodiments. System 600 may comprise a regression model 642. Regression model 642 may be configured to process linear components of input signal 601. The linear components may be adjusted based on a moving average of a regression model. The moving average may be based on certain measured properties of the input signal 601. The moving average may be based on time samples over a period of time. The period of time may comprise, for example, 10 ms. Input signal 601 may be represented by x(n). Input signal 601 may comprise a digital signal. System 600 may comprise filter 652. Filter 652 may comprise one or more filters. Filter 652 may be configured for time domain processing of one frame of input 601, one frame at a time, in realtime. For example, filter 652 may comprise a Finite Impulse Response (FIR) filter and/or an Infinite Impulse Response (IIR) filter. System 600 may be configured to communicate with SME device 614. SME device 614 may be configured to receive one or more listener preferences communicated from crest factor control module 620. A listener 602 may select one or more preferences through utilization of listener device 622. Filter 652 may receive one or more hearing loss intervention parameters from the self-fitting module 650. Self-fitting module 650 may be configured to perform hearing aid fitting. For example, self-fitting module 650 may comprise a patient device (e.g., 410), an LM/AI search machine (e.g., 420), a listening aid sound processing module configured with CFV for sound processing (e.g., 440), and a listen-screen module comprising IntOps for intelligibility (e.g., 450). Self-fitting module 650 may be configured to communicate with one or more quantized audiogram databases (e.g., 480). Self-fitting module 650 may be configured to receive input from an SME 604 through use of SME device 614. Self-fitting module 650 may be configured to receive one or more listener preferences (e.g., 490). Filter 652 may be based on input from SME 604 through use of SME device 614. System 600 may comprise intensity model 644. Intensity model 644 may be configured to process nonlinear components of input signal 601. Intensity model 644 may be configured with a GUI for volume control, e.g., a slider or a knob to modify the loudness for optimal audibility. This intensity model 644 may receive the loudness setting from the Crest Factor Control module 620. System 600 may comprise a compressive amplification module 654. Compressive amplification module 654 may be configured to apply a gain to the nonlinear components processed by intensity model 644. Compressive amplification module 654 may be based on a piecewise linear approximation of a nonlinear function. System 600 may comprise signal reconstruction module 660. Signal reconstruction module 660 may be configured to combine the output of filter 652 with the output of compressive amplification module 654. Signal reconstruction module 660 may be configured to reconstruct filtered linear components of input signal 601 with amplified nonlinear components of input signal 601. Signal reconstruction module 660 may be configured to produce output signal 602. Output signal 602 may be represented by y(n). System 600 may be utilized to acquire listener preferences.

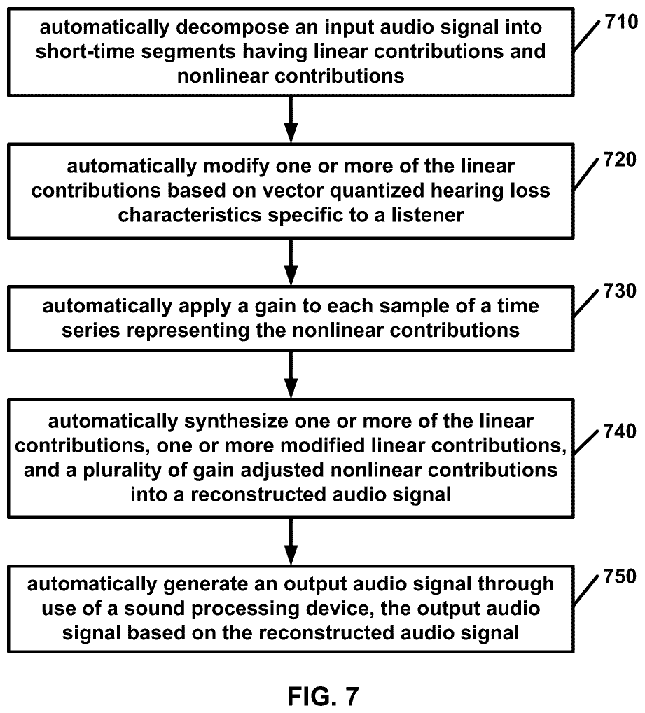

FIG. 7 depicts a flow diagram of an example process for processing audio signals for hearing loss compensation, consistent with disclosed embodiments. An input signal may be automatically decomposed into short-time segments having linear contributions and nonlinear contributions at 710. One or more of the linear contributions may be automatically modified based on vector quantized hearing loss characteristics specific to a listener at 720. A gain may be automatically applied to each sample of a time series representing the nonlinear contributions at 730. One or more of the linear contributions, one or more modified linear contributions, and a plurality of gain adjusted nonlinear contributions may be automatically synthesized into a reconstructed audio signal at 740. An output audio signal may be automatically generated through use of a sound processing device at 750. The output audio signal may be based on the reconstructed audio signal.

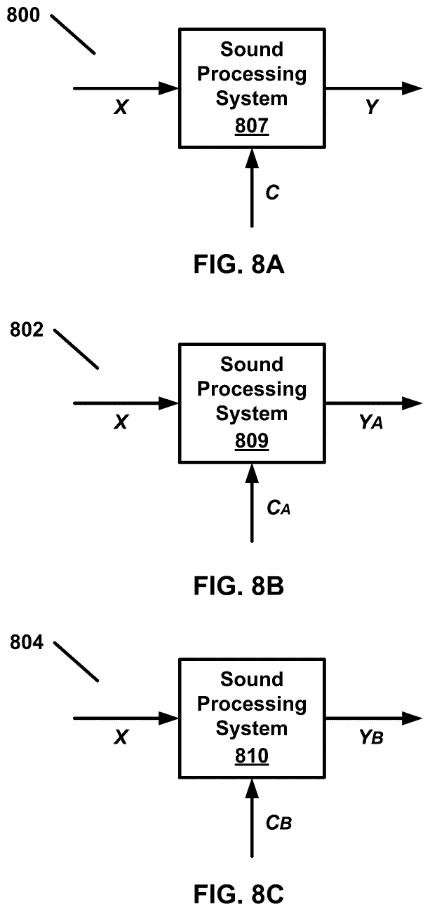

FIG. 8A illustrates a typical linear time invariant system 800. System 800 may comprise sound processing system 807. Sound processing system 807 may comprise a Linear Time Invariant System (LTI). Given two of input X, system state, as specified by control C, and output Y, the third quantity may be exactly computed.

FIG. 8B illustrates a typical nonlinear time varying system 802. System 802 may comprise sound processing system 809. Sound processing system 809 may comprise a nonlinear, time varying (NTV) system. For a system state as defined by C_{A}, and input X, it may not be possible to estimate output Y_{A} to the desired level of accuracy. For example, WDRC used in a conventional hearing aid fitted with NAL-NL2 prescriptive formulae may be an NTV system. Predicting C_{A} that would universally apply to all target audio sources, in all reasonably expected environments, is challenging given typical systems.

FIG. 8C illustrates a piecewise liner, short-time invariant system (PSI) 804, consistent with disclosed embodiments. System 804 may comprise sound processing system 810. Sound processing system 810 may comprise a piecewise linear, short-time invariant System (PSI) by construction, based on the disclosed embodiments. For a given “short-time,” a PSI system may behave practically similar to an LTI system. In some embodiments, CB may be modified about 50 times a second based on certain properties of input X, in realtime. An NTV system may be adapted in accordance with input signal X, resulting in a PSI system. The perceived audio quality and intelligibility of Y_{B} may be improved over Y_{A}.

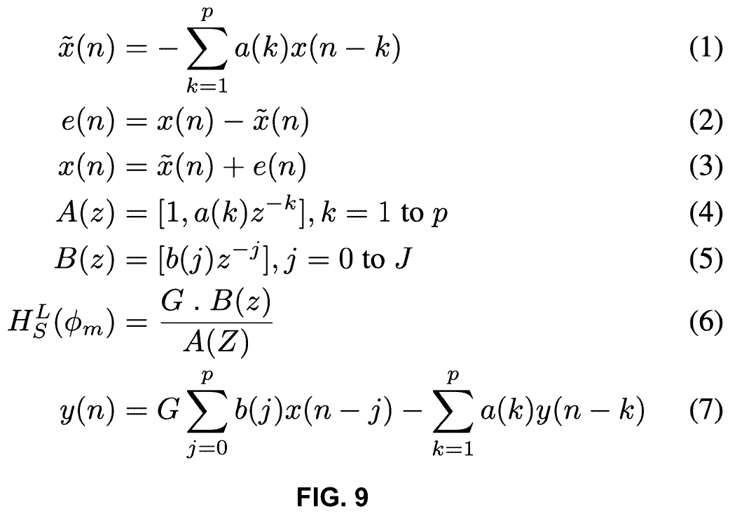

FIG. 9 illustrates exemplary equations related to sound processing, consistent with disclosed embodiments. Equation 1 may represent an approximation of input signal x(n) when performing signal decomposition. Equation 1 may represent a weighted, linear combination of past p samples of x(n). Linear weights may be specified by a(k). In some embodiments, autocorrelation through utilization of Levinson-Durbin recursion may be used to estimate the model parameters a(k). Equation 2 may represent error signal e(n). Equation 2 may represent the nonlinear components of an input signal. The error signal may be referred to as “ignorance” in the model to represent x(n). The error signal may be referred to as “signal innovations” to describe new information that is not captured by the past p samples. Equation 3 may represent complete reconstruction of the input signal by combining the predicted signal and the error signal. Signal decomposition may be based on model parameter a(k). Signal decomposition may be based on model parameter G. A process for sound processing may be configured to perform autocorrelation to derive one or more model parameters. For example, Levinson-Durbin recursion may be performed on the autocorrelation values to derive LPC parameters. A result of Levinson-Durbin recursion may comprise a gain term G. A result of Levinson-Durbin recursion may comprise an all-pole LPC model A(z) shown in Equation 4.

Some embodiments may be configured to compensate for hearing loss described by an audiogram φₘ. Measured audiogram φ may be defined by hearing loss thresholds at a plurality of specific audiometric frequencies. For example, hearing loss thresholds at ten audiometric frequencies may comprise 0.25 kHz, 0.5 kHz, 0.75 kHz, 1 kHz, 1.5 kHz, 2 kHz, 3 kHz, 4 kHz, 6 kHz, and 8 kHz. Hearing loss thresholds may be interpolated to uniform spacing in a frequency domain. A Finite Impulse Response (FIR) filter may be constructed through use of frequency sampling-based FIR filter design. Equation 5 may represent the FIR filter B(z) of order J. Equation 6 may represent a hearing aid system H configured to process audio signals according to sound processing L and fitting protocol S for an audiogram φₘ. B(z) may represent a hearing aid diagnosis. Equation 7 may represent an output signal y(n) for a given input signal x(n).

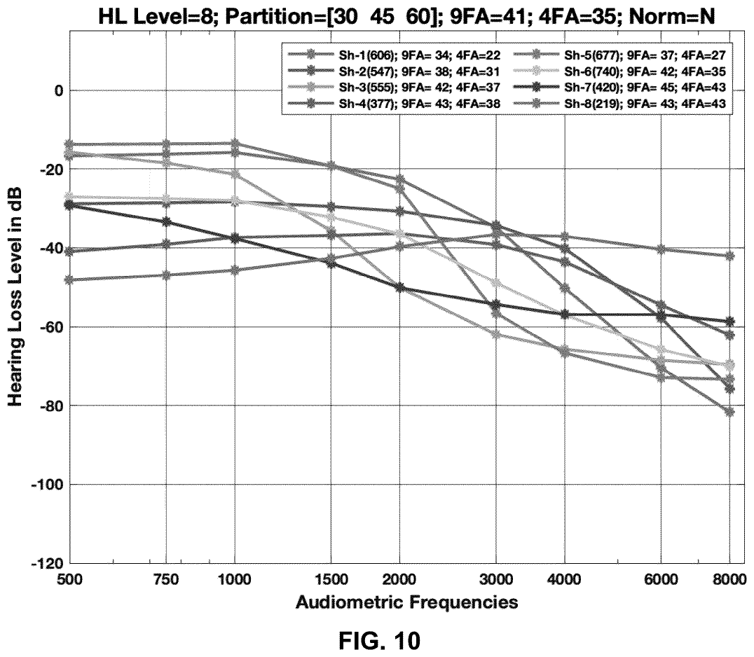

FIG. 10 depicts a set of exemplary quantized audiograms for an exemplary shape search, consistent with disclosed embodiments. A process for listening aid fitting may comprise searching for a hearing loss level. The process for listening aid fitting may comprise searching for a hearing loss shape (shape search). The search for a hearing loss shape may be around a given hearing loss level. The search for a hearing loss shape may comprise a nine frequency average (9FA). This example illustrates quantizing shapes in one of eight audiograms. This number may vary based on the number of audiograms available in a database.

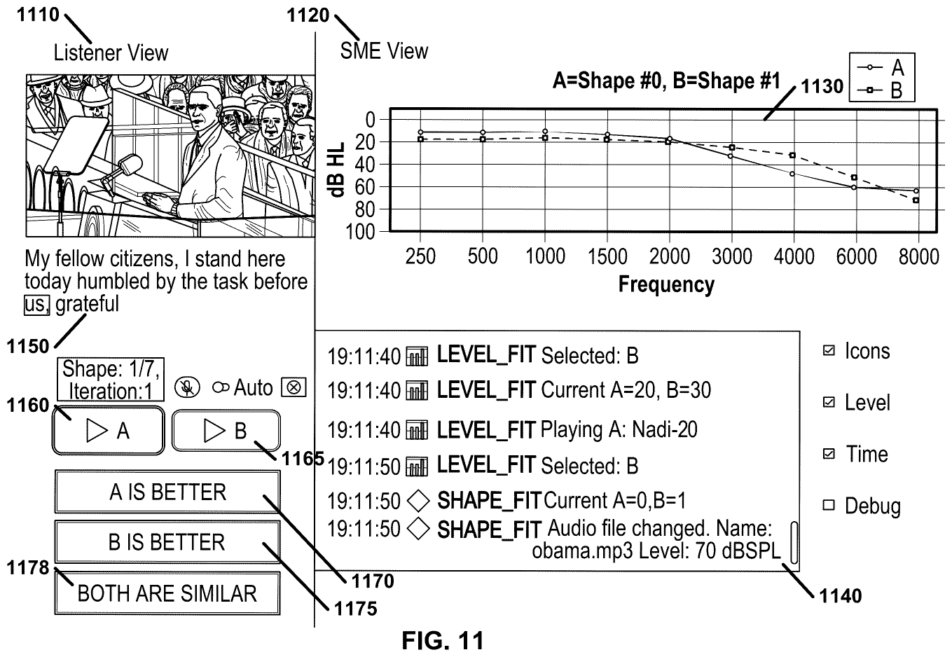

FIG. 11 illustrates exemplary graphical user interfaces for fine resolution listening aid gain selection in listening aid fitting, consistent with disclosed embodiments. The fine resolution listening aid gain selection may be based on audio quality perceived by a listener of a listening aid. A listener graphical user interface may comprise a listener view 1110. The listener view 1110 may be configured to present fine resolution stimuli 1150 to the listener. A fine resolution stimuli may be processed with a set of gain settings to generate two distinct processed fine resolution stimuli. In this example, the listener may play a first of the two distinct processed fine resolution stimuli by selecting a first profile A 1160. In this example, the listener may play a second of the two distinct processed fine resolution stimuli by selecting a second profile B 1165. The listener view 1110 may be configured to present three choices to the listener: A is better 1170, B is better 1175, and both are similar 1178. A system for sound processing may be configured to record a preference selected by the listener. The listener view 1110 may be configured to present a choice of languages for the stimuli to the listener. A multi-lingual listener of a listening aid may choose one of the languages for listening aid fitting. An SME graphical user interface may comprise an SME view 1120. The SME view 1120 may be configured to present one or more vector quantized fine resolution characteristics 1130 specific to the listener. The SME view 1120 may be configured to present a log of activity 1140. The SME view 1120 may be used to present outcomes for one or more fitting processes. The SME view 1120 may be presented to a listening-aid fitting practitioner or SME. The listener view 1110 may also be presented to the listening-aid fitting practitioner or SME. The listening-aid fitting practitioner or SME may be remote from the listener.

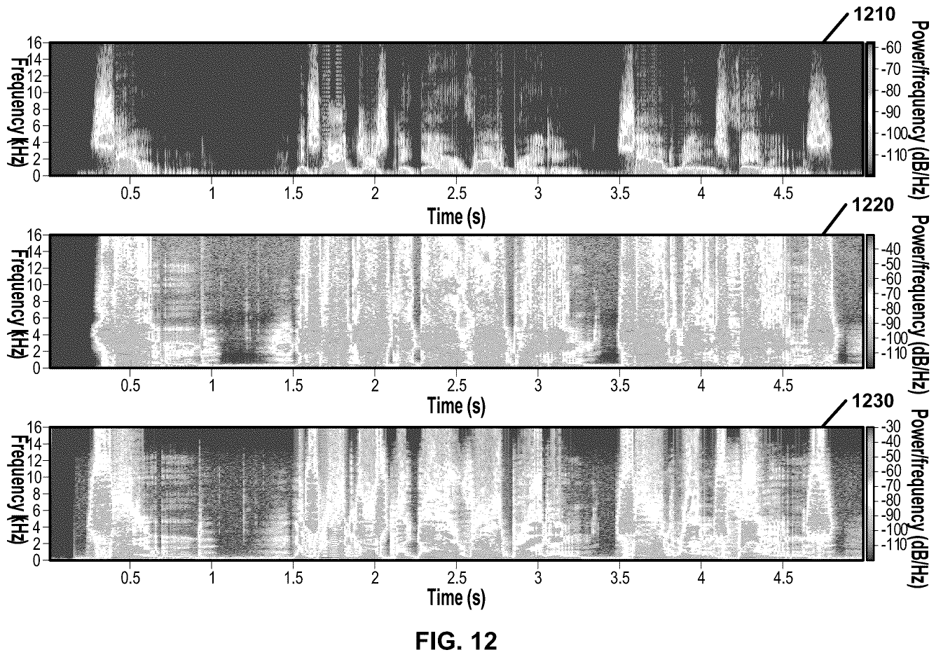

FIG. 12 illustrates spectrograms of a first exemplary audio signal, the first exemplary audio signal processed with a conventional system, and the first exemplary audio signal processed with at least one of the disclosed embodiments. The X axis may represent time in seconds (for example, 0 to 5 seconds). The Y axis may represent frequency (for example, 0 to 16 kHz). The spectrograms may be color coded for intensity in power/frequency. The first spectrogram 1210 is an input audio signal+a gain for audibility. The second spectrogram 1220 is the input audio signal processed through utilization of WDRC. The third spectrogram 1230 is the input audio signal processed through utilization of disclosed embodiments. This example is for a hearing loss=N5.

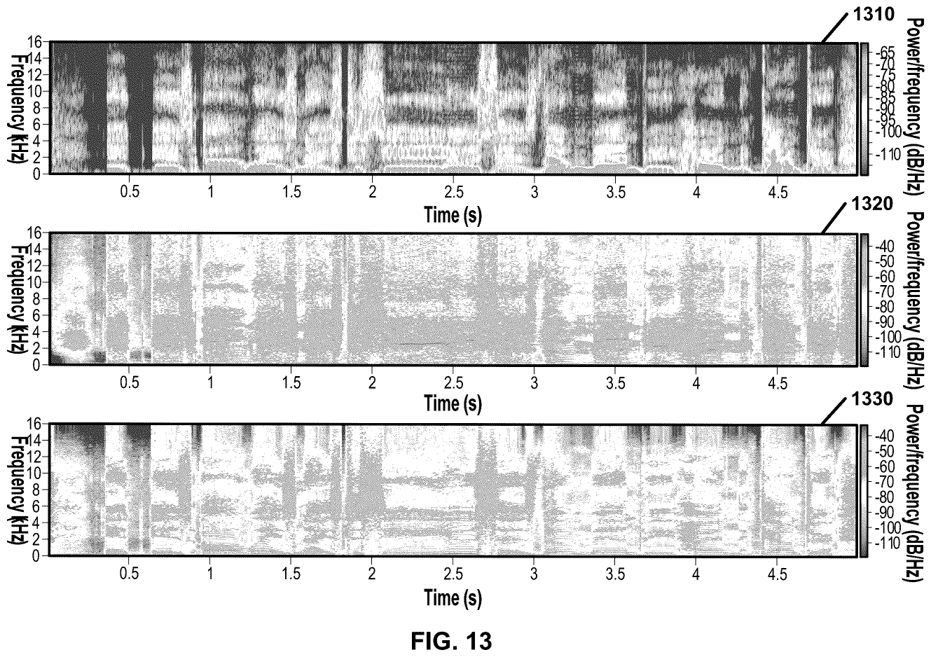

FIG. 13 illustrates spectrograms of a second exemplary audio signal, the second exemplary audio signal processed with a conventional system, and the second exemplary audio signal processed with at least one of the disclosed embodiments. The X axis may represent time in seconds (for example, 0 to 5 seconds). The Y axis may represent frequency (for example, 0 to 16 kHz). The spectrograms may be color coded for intensity in power/frequency. The first spectrogram 1310 is an input audio signal+a gain for audibility. The second spectrogram 1320 is the input audio signal processed through utilization of WDRC. The third spectrogram 1330 is the input audio signal processed through utilization of disclosed embodiments. This example is for a hearing loss=N4.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “a”, “an”, and “one” are not to be interpreted as “only one”. In this specification, the term “may” is to be interpreted as “may, for example.” In other words, the term “may” is indicative that the phrase following the term “may” is an example of one of a multitude of suitable possibilities that may, or may not, be employed to one or more of the various embodiments. In this specification, the phrase “based on” is indicative that the phrase following the term “based on” is an example of one of a multitude of suitable possibilities that may, or may not, be employed to one or more of the various embodiments. References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element), or a combination thereof, all of which are behaviorally equivalent. For example, modules may be implemented using computer hardware in combination with software routine(s) written in a computer language (e.g., Java, HTML, XML, PHP, Python, ActionScript, JavaScript, Ruby, Prolog, SQL, VBScript, Visual Basic, Perl, C, C++, Objective-C, or the like). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers, and microprocessors are programmed using languages such as assembly, C, C++, or the like. FPGAs, ASICs, and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines, and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: flash memory, memory cards, electrically erasable programmable read-only memory (EEPROM), solid state drives, optical disks, barcodes, magnetic ink characters, and/or the like.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described example embodiments. In particular, it should be noted that, for example purposes, listening aid fitting systems may include a server and a mobile device. However, one skilled in the art will recognize that the server and mobile device may vary from a traditional server/device relationship over a network such as the internet. For example, a server may be collective based: portable equipment, broadcast equipment, virtual, application(s) distributed over a broad combination of computing sources, part of a cloud, and/or the like. Similarly, for example, a mobile device may be a user based client, portable equipment, broadcast equipment, virtual, application(s) distributed over a broad combination of computing sources, part of a cloud, and/or the like. Additionally, it should be noted that, for example purposes, several of the various embodiments were described as comprising operations. However, one skilled in the art will recognize that many various languages and frameworks may be employed to build and use embodiments of the present invention.

In this specification, various embodiments are disclosed. Limitations, features, and/or elements from the disclosed example embodiments may be combined to create further embodiments within the scope of the disclosure. Moreover, the scope includes any and all embodiments having equivalent elements, modifications, omissions, adaptations, or alterations based on the present disclosure. Further, aspects of the disclosed methods can be modified in any manner, including by reordering aspects, or inserting or deleting aspects.

In addition, it should be understood that any figures that highlight any functionality and/or advantages, are presented for example purposes only. The disclosed architecture is sufficiently flexible and configurable, such that it may be utilized in ways other than that shown. For example, the blocks presented in any flowchart may be re-ordered or only optionally used in some embodiments.

Furthermore, many features presented above are described as being optional through the use of “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. A system for processing audio signals for hearing loss compensation, the system comprising:
a) a sound processing device configured to generate an output audio signal, the output audio signal based on an input audio signal and one or more sound processing parameter settings;
b) a database comprising vector quantized hearing loss characteristics across a range of auditory frequencies, at least one of the sound processing parameter settings based on vector quantized hearing loss characteristics specific to a listener;
c) at least one memory storing instructions; and
d) at least one processor being configured to execute the instructions to perform operations, the operations comprising:
i) automatically decomposing the input audio signal into a plurality of short-time segments;
ii) automatically decomposing at least one of the short-time segments into distinct sub-segments, a first of the distinct sub-segments having linear contributions and a second of the distinct sub-segments having nonlinear contributions;
iii) automatically modifying one or more of the linear contributions based on the vector quantized hearing loss characteristics specific to the listener;
iv) automatically applying a gain to each sample of a time series representing the nonlinear contributions;
v) automatically synthesizing one or more of the linear contributions, the one or more modified linear contributions, and a plurality of gain adjusted nonlinear contributions into a reconstructed audio signal; and
vi) automatically generating the output audio signal through use of the sound processing device, the output audio signal based on the reconstructed audio signal.

2. The system according to claim 1, wherein decomposing at least one of the short-time segments into distinct sub-segments comprises performing model projections.

3. The system according to claim 2, wherein the linear contributions are based on the model projections.

4. The system according to claim 2, wherein decomposing at least one of the short-time segments into distinct sub-segments comprises identifying signal components omitted by the model.

5. The system according to claim 4, wherein the nonlinear contributions are based on the signal components omitted by the model.

6. The system according to claim 1, wherein the gain is selected by a user.

7. The system according to claim 1, wherein additional gain is automatically selected based on the vector quantized hearing loss characteristics specific to the listener.

8. The system according to claim 1, wherein the vector quantized hearing loss characteristics specific to the listener are determined through one or more selections of preferred audio processing of a stimulus by the listener.

9. The system according to claim 1, wherein the gain is based on one or more listener preferences.

10. The system according to claim 1, wherein the synthesizing is based on one or more listener preferences.

11. A method for processing audio signals for hearing loss compensation, the method comprising:
a) automatically decomposing an input audio signal into a plurality of short-time segments;
b) automatically decomposing at least one of the short-time segments into distinct sub-segments, a first of the distinct sub-segments having linear contributions and a second of the distinct sub-segments having nonlinear contributions;
c) automatically modifying one or more of the linear contributions based on vector quantized hearing loss characteristics specific to a listener;
d) automatically applying a gain to each of the nonlinear contributions;
e) automatically synthesizing one or more of the linear contributions, one or more modified linear contributions, and a plurality of gain adjusted nonlinear contributions into a reconstructed audio signal; and
f) automatically generating an output audio signal through use of a sound processing device, the output audio signal based on the reconstructed audio signal.

12. The method according to claim 11, wherein the decomposing at least one of the short-time segments into distinct sub-segments comprises performing model projections.

13. The method according to claim 12, wherein the linear contributions are based on the model projections.

14. The method according to claim 12, wherein the decomposing at least one of the short-time segments into distinct sub-segments comprises identifying signal components omitted by the model.

15. The method according to claim 14, wherein the nonlinear contributions are based on the signal components omitted by the model.

16. The method according to claim 11, wherein the gain is selected by a user.

17. The method according to claim 11, wherein additional gain is automatically selected based on the vector quantized hearing loss characteristics specific to the listener.

18. The method according to claim 11, wherein the vector quantized hearing loss characteristics specific to the listener are determined through one or more selections of preferred audio processing of a stimulus by the listener.

19. The method according to claim 11, wherein the gain is based on one or more listener preferences.

20. The method according to claim 11, wherein the synthesizing is based on one or more listener preferences.
